(19) United States
(12) Patent Application Publication
(10) Pub. No.: US 2016/0239200 A1
(43) Pub. Date: Aug. 18, 2016

(54) System and Method for Multi-Touch Gestures

(71) Applicant: Futurewei Technologies, Inc., Plano, TX (US)

(72) Inventor: Zenghua Fang, San Diego, CA (US)

(21) Appl. No.: 14/623,323

(22) Filed: Feb. 16, 2015

(51) Int. Cl. G06F 3/0488

(52) U.S. Cl. CPC G06F 3/04883

(57) ABSTRACT

In one embodiment, a method includes receiving, by a touch screen display of a device from a user, a gesture on the touch screen display of the device and determining whether the gesture is a multi-touch gesture on a plurality of objects displayed on the touch screen display of the device. The method also includes producing a detected multi-touch gesture when the gesture is the multi-touch gesture on the plurality of objects displayed on the touch screen display of the device and performing an operation on the plurality of objects in accordance with the detected multi-touch gesture.

### TECHNICAL FIELD

The present invention relates to a system and method for user interfaces, and, in particular, to a system and method for multi-touch gestures.

### BACKGROUND

Devices such as smartphones, tablets, and phablets may support multi-touch. Multi-touch refers to the ability of a surface, such as a trackpad or touchscreen, to recognize the presence of multiple points of contact with the surface. Multi-touch may be implemented in a variety of technologies, such as capacitive technologies, resistive technologies, optical technologies, wave technologies, and force-sensing touch technologies. For example, multi-touch gestures may be applied by a user to an object or the entire screen.

Large screen smartphones, tablets, and phablets may support multitasking in multiple windows. Multiple applications may run simultaneously in multiple windows with a split screen. In multitasking, multiple tasks are executed concurrently.

### SUMMARY

An embodiment method includes receiving, by a touch screen display of a device from a user, a gesture on the touch screen display of the device and determining whether the gesture is a multi-touch gesture on a plurality of objects displayed on the touch screen display of the device. The method also includes producing a detected multi-touch gesture when the gesture is the multi-touch gesture on the plurality of objects displayed on the touch screen display of the device and performing an operation on the plurality of objects in accordance with the detected multi-touch gesture.

An embodiment device includes a touch-screen display configured to receive a gesture on the touch screen display and a processor. The device also includes a non-transitory computer readable storage medium storing programming for execution by the processor. The programming includes instructions to determine whether the gesture is a multi-touch gesture on a plurality of objects displayed on the touch screen display of the device and produce a detected multi-touch gesture when the gesture is the multi-touch gesture on the plurality of objects displayed on the touch screen display of the device. The programming also includes instructions to perform an operation on the plurality of objects in accordance with the detected multi-touch gesture.

An embodiment computer program product for installation on a device, the computer program product includes programming for execution by the device. The programming includes instructions to receive, by a touch screen display of a device from a user, a gesture on the touch screen display of the device and determine whether the gesture is a multi-touch gesture on a plurality of objects displayed on the touch screen display of the device. The programming also includes instructions to produce a detected multi-touch gesture when the gesture is the multi-touch gesture on the plurality of objects displayed on the touch screen display of the device and perform an operation on the plurality of objects in accordance with the detected multi-touch gesture.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a diagram of a wireless network for communicating data;

FIGS. 2A-B illustrates an embodiment display with multi-touch stretching performed on four icons;

FIGS. 3A-B illustrate embodiment displays with multi-touch stretching performed on two icons;

FIG. 4 illustrates an embodiment display with multi-touch pinching performed on four icons;

FIG. 5 illustrates an embodiment display with multi-touch pinching performed on four pictures;

FIG. 6 illustrates an embodiment display with multi-touch pinching performed on four windows;

FIG. 7 illustrates an embodiment display with multi-touch rotation performed on four icons;

FIG. 8 illustrates an embodiment display with multi-touch rotation performed on four pictures;

FIG. 9 illustrates an embodiment display with multi-touch rotation performed on four windows;

FIG. 10 illustrates an embodiment display with multi-touch holding performed on four pictures;

FIG. 11 illustrates an embodiment display with multi-touch dragging performed on three icons;

FIG. 12 illustrates a flowchart of an embodiment method of performing multi-touch gestures on multiple objects;

FIG. 13 illustrates a flowchart of an embodiment method of multi-touch stretching performed on multiple objects;

FIG. 14 illustrates a flowchart of an embodiment method of multi-touch pinching performed on multiple objects;

FIG. 15 illustrates a flowchart of an embodiment method of multi-touch rotation performed on multiple objects;

FIG. 16 illustrates a flowchart of an embodiment method of multi-touch holding performed on multiple objects;

FIG. 17 illustrates a flowchart of an embodiment method of multi-touch dragging performed on multiple objects; and

FIG. 18 illustrates a block diagram of an embodiment computer system.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In one example, multiple object icons associated with a single object icon are rendered by detecting fingers moving apart. For example, two fingers touching an object on a screen are detected by a touch sensitive display. When the fingers move in opposite directions, additional object icons appear on the display, which represent constituent elements of the original object icon.

In another example, single touch gestures are defined. Single touch gestures may include tapping, pressing and holding, sliding, tapping/tapping-sliding, pinching or stretching, rotation, swiping to select, sliding to rearrange, and swiping from an edge. In an additional example, single touch gestures include tapping, pressing, two digit tapping, double tapping, three digits swiping, and pinching.

In an additional example, multiple finger gestures act on a single object or on the whole screen. Example gestures include two to four fingers double tapping, swiping, and pinching.

In an embodiment, multiple objects are acted on by a one-step multi-touch gesture. For example, multiple objects may be combined, moved, rotated, or launched by a multi-touch gesture. A multi-touch gesture is a gesture performed by more than one member, where a member may be a finger, stylus, pen, etc. For example, a multi-touch gesture may be performed by two or more fingers. Multi-touch gestures include stretching, pinching, rotating, holding, dragging, etc. Objects are displayed in different areas of the screen. In one example, objects are separated with space between objects. Alternatively, objects are adjacent to each other. Examples of objects include icons, applications, pictures, windows, and other objects, such as videos. One or two hands may be used in a multi-touch gesture.

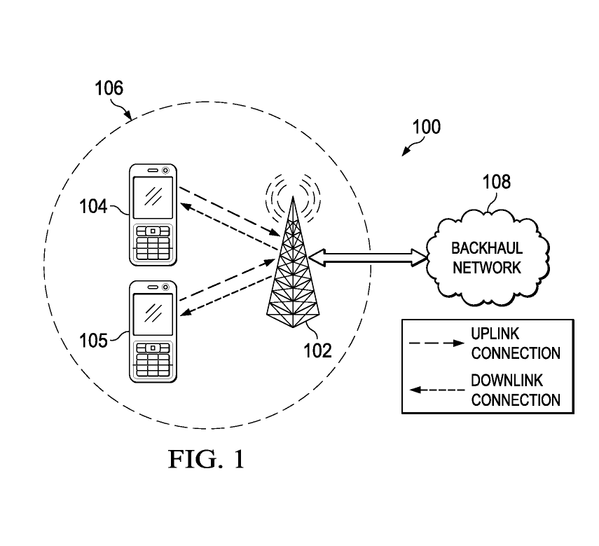

FIG. 1 illustrates network 100 for communicating data. Network 100 includes communications controller 102 having a coverage area 106, a plurality of user equipments (UEs), including UE 104 and UE 105, and backhaul network 108. Two UEs are depicted, but many more may be present. Communications controller 102 may be any component capable of providing wireless access by establishing uplink (dashed line) and/or downlink (dotted line) connections with UE 104 and UE 105, such as a base station, a NodeB, an enhanced nodeB (eNB), an access point, a picocell, a femtocell, and other wirelessly enabled devices. UE 104 and UE 105 may be any component capable of establishing a wireless connection with communications controller 102, such as cell phones, smart phones, tablets, sensors, etc. Backhaul network 108 may be any component or collection of components that allow data to be exchanged between communications controller 102 and a remote end. In some embodiments, the network 100 may include various other wireless devices, such as relays, etc. An embodiment is implemented on a UE, such as UE 104 or UE 105.

A UE may have a touch-screen display with both an output interface and an input interface. A touch-screen system may include a display, sensors, a controller, and software. The touch-screen display displays visual output to the user, such as text, graphics, video, or a combination of outputs. The user may directly interact with the display. Some or all of the visual output may correspond to user-interface objects. User-interface objects include icons representing applications, windows, pictures, or other objects, such as videos.

The display of the touch-screen display displays objects to the user. The display may use a liquid crystal display (LCD), or another display, such as a light emitting diode (LED) display.

The touch-screen sensor(s) detect a touch by a user, directly or indirectly, on the touch-screen display. The objects are visible to the user, facilitating the user directly interacting with the objects. The touch-screen display accepts input from a user based on haptic and/or tactile contacts. A touch-screen display may use a special stylus or pen and/or one or more fingers. In one example, ordinary or specially coated gloves are worn by the user. Touch-screen displays may use a variety of technologies, such as resistive technology, surface acoustic waves (SAW), capacitive technology, infrared grid, infrared acrylic projection, optical imaging, dispersive signal technology, and/or acoustic pulse technology.

A resistive touch-screen display may include multiple layers, including two thin, transparent electrically resistive layers facing each other separated by a thin space. The top layer, which is touched by the user, has a coating on its lower surface. The lower layer has a similar coating on its upper surface. One layer has conductive connections along its sides, while the other layer has conductive connections along its top and bottom. A voltage is applied to one layer and sensed by the other layer. When an object, such as a fingertip or stylus tip, presses down on the outer surface, the two layers touch, forming a connection at the pressed point. The touch-screen display then acts as a pair of voltage dividers one axis at a time. By rapidly switching between the two layers, the position of the tip on the screen is read.

SAW technology uses ultrasonic waves which pass over the touch-screen display. When the touch-screen display is touched, a portion of the wave is absorbed. The change in the ultrasonic waves registers the position of the touch event, and the information is sent to the controller for processing.

A capacitive touch-screen display has an insulator, such as glass, coated with a transparent conductor, such as indium tin oxide (ITO). Because the human body is a good conductor, when a finger touches the surface of the screen, there is a distortion of the screen's electrostatic field, which results in a change in capacitance. The change in capacitance is measured. A variety of technologies may be used to determine the location of the touch, with is sent to the controller for processing. In one example, the capacitors are built into the screen itself.

In surface capacitance, only one side of an insulator is coated with a conductive layer. A small voltage is applied to the layer, leading to a uniform electrostatic field. When a conductor, such as a human finger, touches the uncoated surface, a capacitor is dynamically formed. The sensor's controller may determine the location of the touch indirectly from the change in the capacitance measured from the four corners of the panel.

In projected capacitive touch (PCT) technology, touch-screen displays have a matrix of rows and columns of conductive material layered on sheets of glass. The layering may be performed by etching a single conductive layer to form a grid pattern of electrodes or by etching two separate, perpendicular layers of conductive material with parallel lines or tracks to form a grid. A voltage is applied to the grid, creating a uniform electrostatic field, which may be measured. When a conductive object, such as a finger, comes into contact with a PCT, it distorts the local electrostatic field at that point, leading to a measurable change in capacitance. When a finger bridges the gap between two of the tracks, the charge field is further interrupted, and may be detected by a controller. The capacitance may be changed and measured at every intersection of the grid to accurately locate touches. Two types of PCT are mutual capacitance and self-capacitance. Most conductive objects hold a charge when they are close together. In mutual capacitance, a capacitor is inherently formed by the row trace and column trace at the intersections of the grid. A voltage is applied to the rows or column. When a finger or conductive stylus is close to the surface of the sensor, changes in the local electrostatic field reduce the mutual capacitance. The capacitance change at the intersections may be measured to determine the location of the touch by measuring the voltage in the axis to which the voltage is not applied. In self-capacitance, columns and rows of a grid operate independently. The capacitive load of a finger is measured on each column or row electrode by a current meter.

An infrared grid uses an array of LED and photodetector pairs around the edges of the screen to detect a disruption in the pattern of LED beams. The LED beams cross each other in vertical and horizontal patterns, to facilitate the sensors locating the touch.

In infrared acrylic projection, a translucent acrylic sheet is used as a rear projection screen to display information. The edges of the acrylic sheet are illuminated by infrared LEDs, and infrared cameras are focused on the back of the sheets. Objects placed on the acrylic sheet are detectable by the cameras. When the sheet is touched by the user, the deformation leads to leakage of the infrared light, which peaks at the points of maximum pressure, indicating the user's touch location.

In optical imaging, two or more image sensors are placed around the edges of the screen, for example at the corners. Infrared back lights are placed in the camera's field of view on the opposite side of the screen to the sensors. A touch shows up as a shadow. The pair of cameras may pinpoint the location of the touch.

In dispersive signal technology, the piezoelectricity in a glass from a touch is detected. Algorithms interpret this information to provide the location of the touch.

In acoustic pulse recognition, a touch at a position on the surface of the touch-screen display generates a sound wave in the substrate, which produces a unique combined sound after being picked up by three or more transducers attached to the edges of the touch-screen display. The sound is digitized by a controller, and compared to a list of pre-recorded sounds for positions on the surface. The cursor position is updated to the touch location. A moving touch is tracked by rapid repetition. Extraneous and ambient sounds are ignored, because they do not match the stored sound profiles.

A controller interacts with the touch-screen sensor(s) for a variety of sensor types. The controller may be embedded in the system as a chip, for example located on a controller board or on a flexible printed circuit (FPC) on the touch sensor. The controller receives information from the sensor(s) and translates it into information that a central processing unit (CPU) or embedded system controller understands.

Software running on a CPU or embedded system controller facilitates the touch-screen display working with the system controller and operating system (OS), so the system controller knows how to interpret the touch event information from the controller.

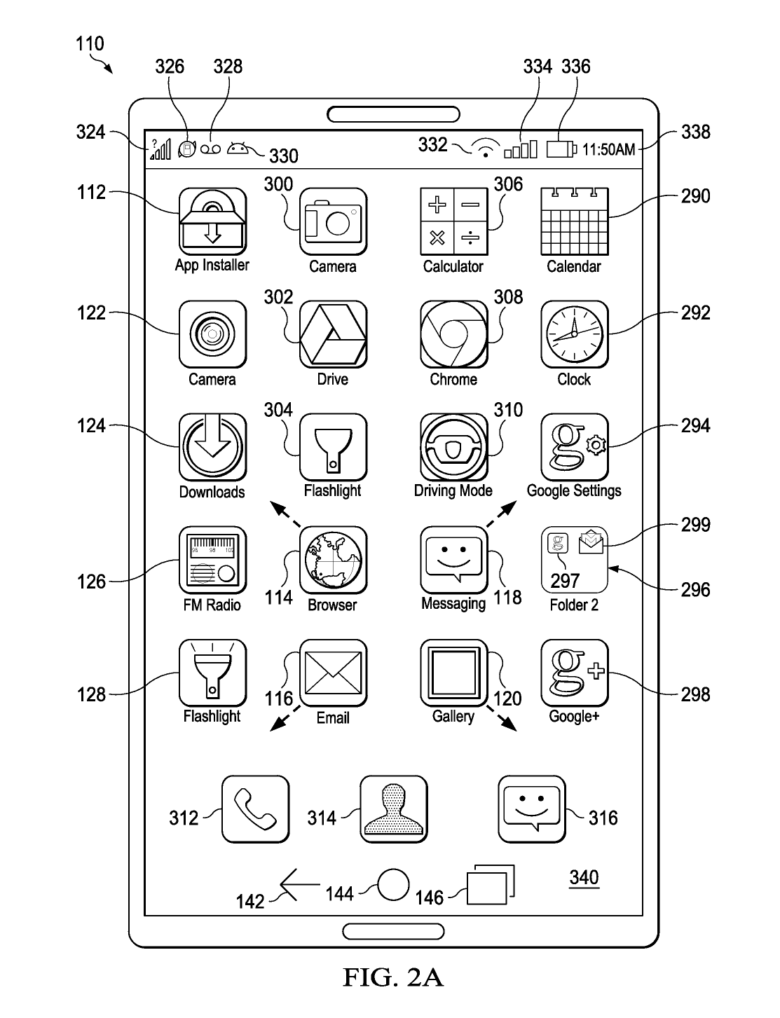

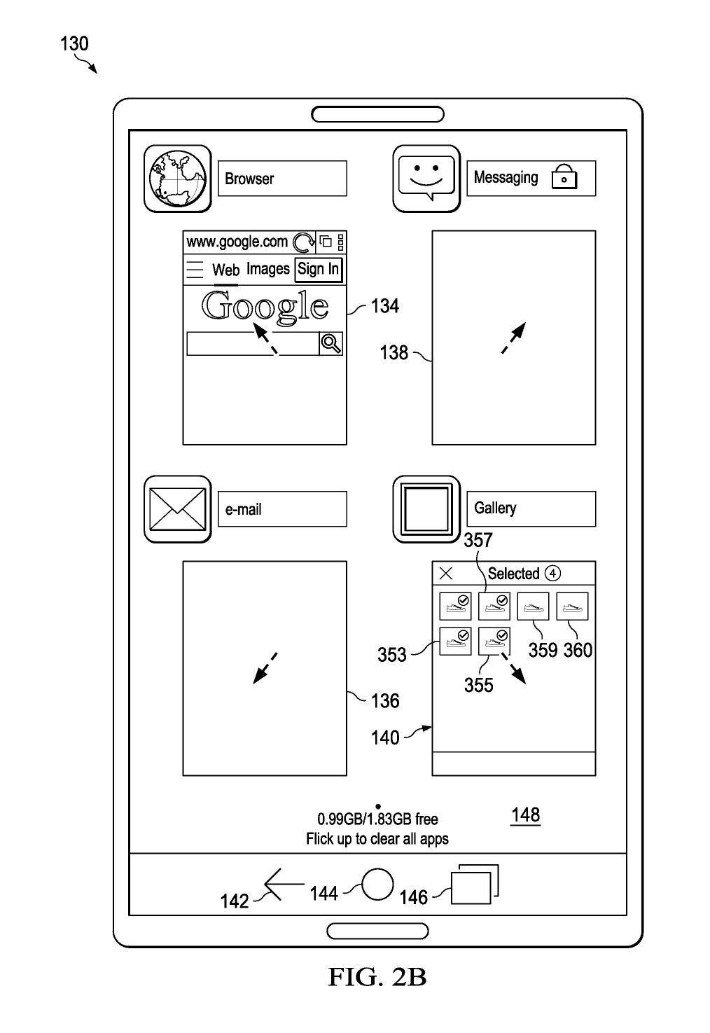

In one embodiment, a stretch multi-touch gesture acts on multiple objects. Two, three, four, or more fingers may be used to act on multiple objects in a stretching motion. FIGS. 2A-B illustrate multi-touch stretching being used to open four windows corresponding to four icons. The number of fingers used may be the same as the number of objects. Alternatively, fewer or more fingers are used. For example, two fingers may act on two objects each for a total of four icons. FIG. 2A illustrates display 110 with background 340, cellular signal strength indicator 324, indicator 326, new voicemail indicator 328, indicator 330, WiFi strength indicator 332, battery level indicator 334, charging status indicator 336, and clock 338. Also, display 110 contains back button 142, home button 144, and menu button 146. Display 110 also includes a variety of icons, including phone icon 312, contacts icon 314, messaging icon 316, application (App) installer icon 112, camera icon 300, calculator icon 306, calendar icon 290, camera icon 122, Google Drive™ icon 302, Google Chrome™ icon 308, clock icon 292, downloads icon 124, flashlight icon 304, driving mode icon 310, Google™ settings icon 294, frequency modulation (FM) radio icon 126, browser icon 114, messaging icon 118, folder icon 296, which contains Google™ icon 297 and mail icon 299, flashlight icon 128, e-mail icon 116, gallery icon 120, and Google+™ icon 298. Stretching is performed on browser icon 114, e-mail icon 116, messaging icon 118, and gallery icon 120 to open the applications corresponding to those icons. For example, a browser, messaging center, e-mail center, and gallery may be opened by a single multi-touch gesture. Four fingers are placed on browser icon 114, e-mail icon 116, messaging icon 118, and gallery icon 120, and a stretching motion is performed to open the four applications. The four applications are opened in separate windows.

FIG. 2B illustrates display 130 of a smartphone with the results of the stretching motion on browser icon 114, e-mail icon 116, messaging icon 118, and gallery icon 120 are illustrated by display 130 in FIG. 2B. Display 130 also includes background 148, back button 142, home button 144, and menu button 146. The open windows include browser window 134, messaging window 138, map e-mail 136, and gallery window 140. Gallery window 140 includes pictures 351, 353, 355, 357, 359, and 360. The icons acted upon may be in different portions of the screen, or they may be in the same portion of the screen, as pictured.

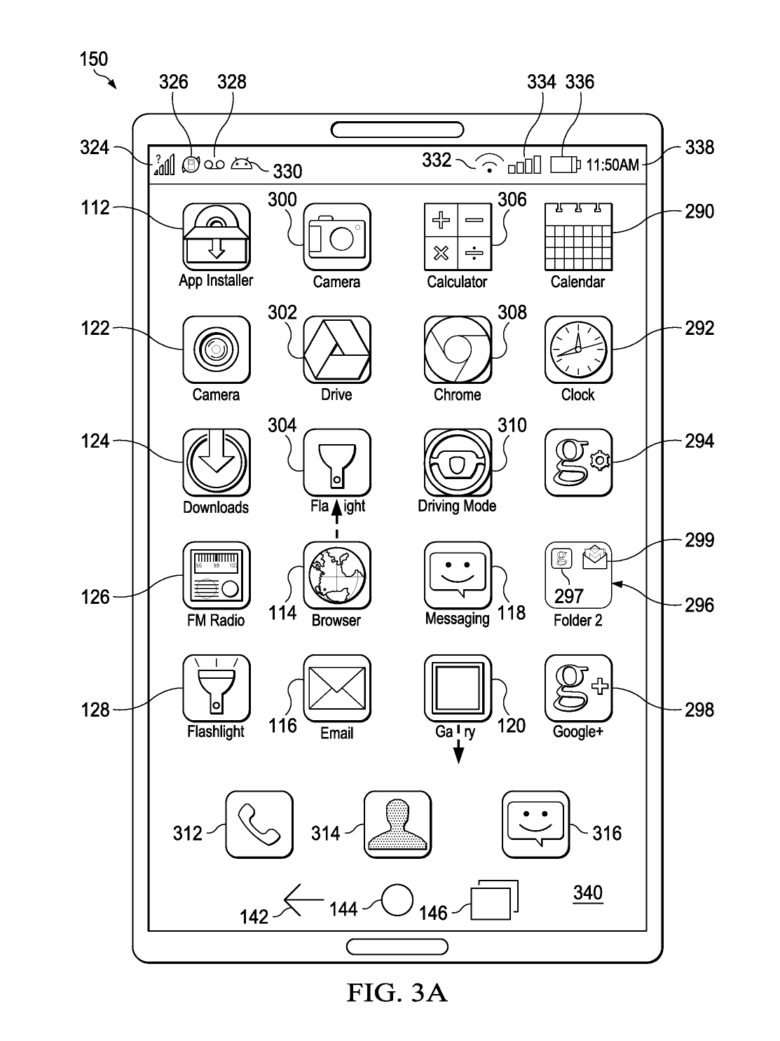

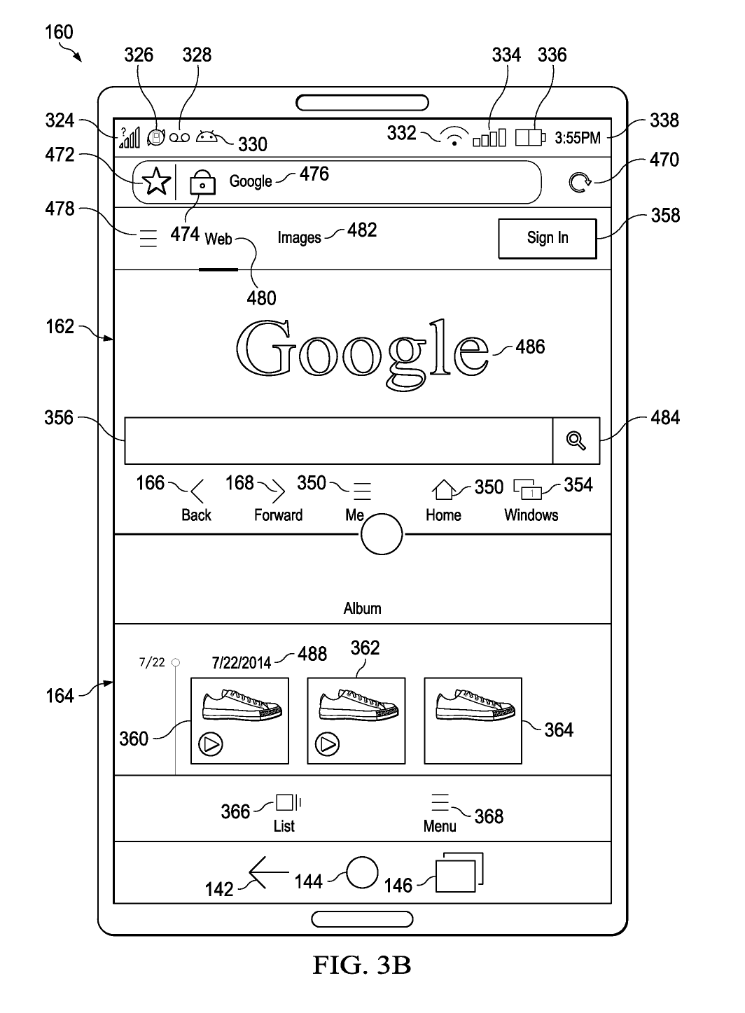

FIGS. 3A-B illustrate a multi-touch stretching motion performed on two icons to open two corresponding windows. FIG. 3A illustrates display 150 of a smartphone with background 340, cellular signal strength indicator 324, indicator 326, new voicemail indicator 328, indicator 330, WiFi strength indicator 332, battery level indicator 334, charging status indicator 336, and clock 338. Also, display 150 contains back button 142, home button 144, and menu button 146. Additionally, display 150 includes a variety of icons, including phone icon 312, contacts icon 314, messaging icon 316, application installer icon 112, camera icon 300, calculator icon 306, calendar icon 290, camera icon 122, Google Drive™ icon 302, Google Chrome™ icon 308, clock icon 292, downloads icon 124, flashlight icon 304, driving mode icon 310, Google™ settings icon 294, FM radio icon 126, browser icon 114, messaging icon 118, folder icon 296, which contains Google™ icon 297 and mail icon 299, flashlight icon 128, e-mail icon 116, gallery icon 120, and Google+™ icon 298. Two icons, browser icon 114 and gallery icon 120 are acted upon by placing two fingers on the icons and moving one finger up and one finger down. In other examples, icons are acted on generally moving the fingers apart from each other, such as by moving one finger left and the other finger right, or by moving the fingers at another angle, such as diagonally.

FIG. 3B illustrates display 160 of a smartphone after browser icon 114 and gallery icon 120 have been opened. Display 160 includes cellular signal strength indicator 324, indicator 326, new voicemail indicator 328, indicator 330, WiFi strength indicator 332, battery level indicator 334, charging status indicator 336, and clock 338, back button 142, home button 144, menu button 146, browser window 162, and album window 164. Browser window 162 contains back button 470, bookmark button 472, lock button 474, Google™ icon 476, sign in button 358, settings button 478, web button 480, images button 482, Google™ logo 486, search bar 356, search button 484, back button 166, forward button 168, menu button 350, home button 352, and windows button 354. Album window 164 contains pictures 360, 362, and 364, timestamp 488, list button 366, and menu button 368.

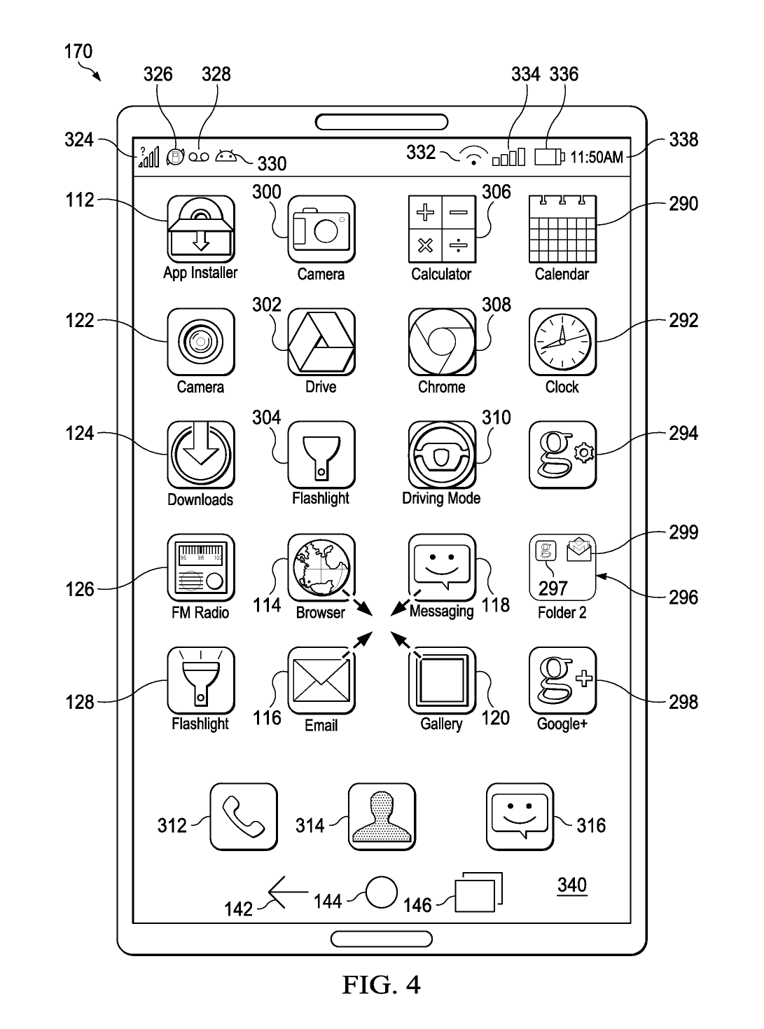

In another example, a pinching motion is performed on multiple objects to perform an operation on the objects acted upon. In a pinching motion, two, three, four or more fingers are placed on objects and drawn inwards towards each other. In FIG. 4, display 170 contains background 340, cellular signal strength indicator 324, indicator 326, new voicemail indicator 328, indicator 330, WiFi strength indicator 332, battery level indicator 334, charging status indicator 336, and clock 338. Display 170 also contains back button 142, home button 144, and menu button 146. Display 170 includes a variety of icons, including phone icon 312, contacts icon 314, messaging icon 316, application installer icon 112, camera icon 300, calculator icon 306, calendar icon 290, camera icon 122, Google Drive™ icon 302, Google Chrome™ icon 308, clock icon 292, downloads icon 124, flashlight icon 304, driving mode icon 310, Google™ settings icon 294, FM radio icon 126, browser icon 114, messaging icon 118, folder icon 296 containing Google™ icon 297 and mail icon 299, flashlight icon 128, e-mail icon 116, gallery icon 120, and Google+™ icon 298. A user performs a multi-touch pinching gesture on browser icon 114, e-mail icon 116, messaging icon 118, and gallery icon 120. The pinching action causes the four applications corresponding to these icons to be combined into a folder. In other examples, fewer or more icons, pictures, or other documents are combined into a folder using multi-touch pinching.

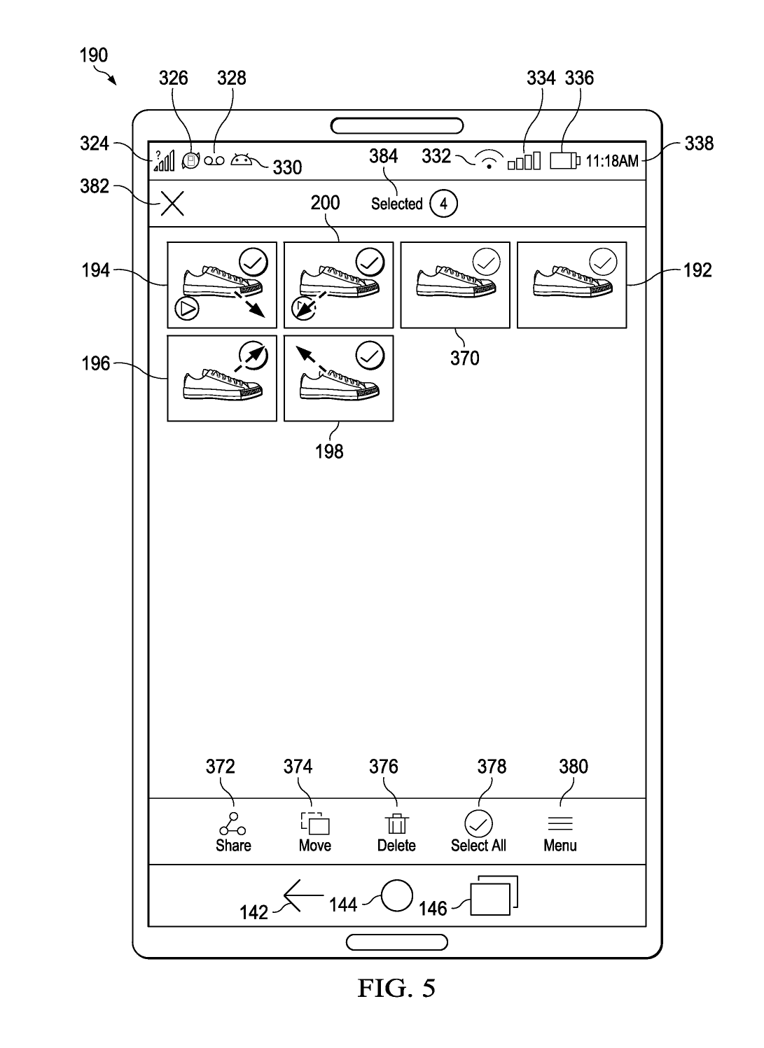

FIG. 5 illustrates display 190 of a smartphone, with pictures 194, 196, 198, 200, 370, and 192. Display 190 also includes cellular signal strength indicator 324, indicator 326, new voicemail indicator 328, indicator 330, WiFi strength indicator 332, battery level indicator 334, charging status indicator 336, clock 338, back button 142, home button 144, and menu button 146. Additionally, display 190 contains close window button 382, selection indicator 384, share button 372, move button 374, delete button 376, select all button 378, and menu button 380. A user places fingers on pictures 194, 196, 198, and 200, which are selected. The fingers perform a pinching motion, which combines these four pictures into one larger picture. The pictures may be aligned and knitted together to form one smooth larger picture.

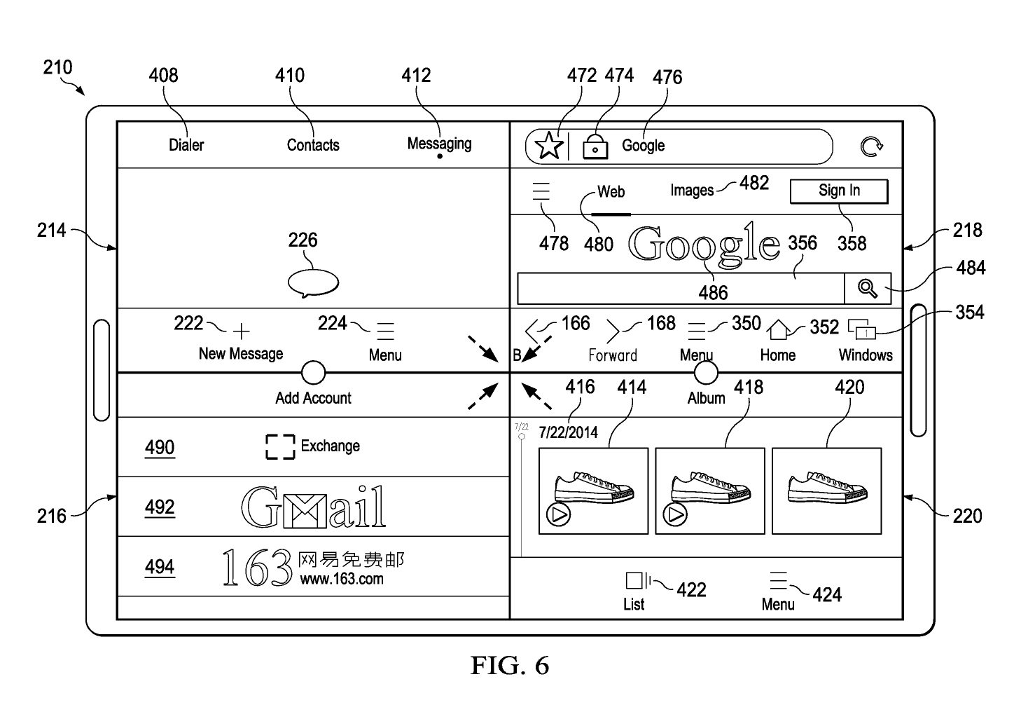

FIG. 6 illustrates display 210 of a tablet. Four windows, messaging center window 214, e-mail exchange window 216, web browser window 218, and photo album window 220 are open. Messaging center window 214 includes dialer button 408, contacts button 410, messaging button 412, message display 226, new message button 222, and menu button 224. The messaging center is used to send and receive messages. Also, e-mail exchange window 216 contains an e-mail exchange to send and receive messages, with exchange button 490, Gmail™ button 492, and 163 web portal button 494. Web browser window 218 illustrates a Google Chrome™ web browser with bookmark button 472, lock button 474, Google™ icon 476, sign in button 358, settings button 478, web button 480, images button 482, Google™ logo 486, search bar 356, search button 484, back button 166, forward button 168, menu button 350, home button 352, and windows button 354. Additionally, photo album window 220 contains a photo album with pictures 414, 418, and 420, timestamp 416, list button 422, and menu button 424. A user places a finger on each window, and performs a pinching motion, causing the four windows to close simultaneously.

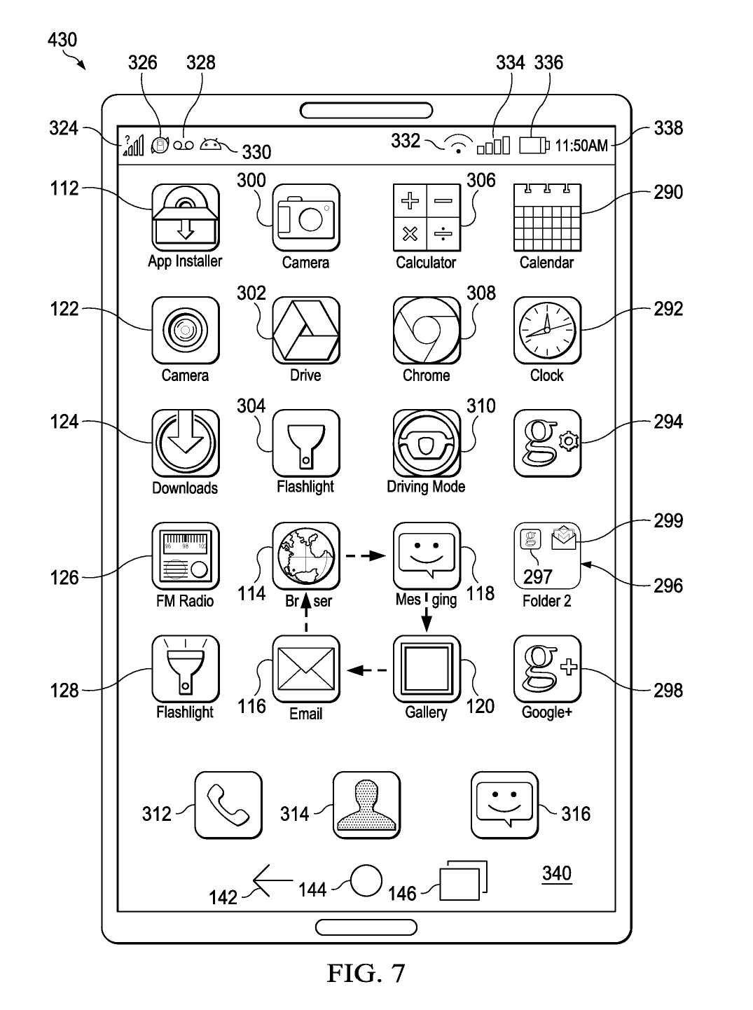

In an additional example, a multi-touch rotation action is performed on multiple objects. FIG. 7 illustrates display 430 of a smartphone, where multi-touch rotation is performed on icons. Display 430 depicts background 340, cellular signal strength indicator 324, indicator 326, new voicemail indicator 328, indicator 330, WiFi strength indicator 332, battery level indicator 334, charging status indicator 336, and clock 338. Additionally, display 430 contains back button 142, home button 144, and menu button 146. Display 430 also includes a variety of icons, including phone icon 312, contacts icon 314, messaging icon 316, application installer icon 112, camera icon 300, calculator icon 306, calendar icon 290, camera icon 122, Google Drive™ icon 302, Google Chrome™ icon 308, clock icon 292, downloads icon 124, flashlight icon 304, driving mode icon 310, Google™ settings icon 294, FM radio icon 126, browser icon 114, messaging icon 118, folder icon 296, which contains Google™ icon 297 and mail icon 299, flashlight icon 128, e-mail icon 116, gallery icon 120, and Google+™ icon 298. A multi-touch rotation is performed on browser icon 114, messaging icon 118, gallery icon 120, and e-mail icon 116. A clockwise rotation motion is performed to these icons, which rotates the position of the icons in the display. In another example a counter-clockwise motion is used.

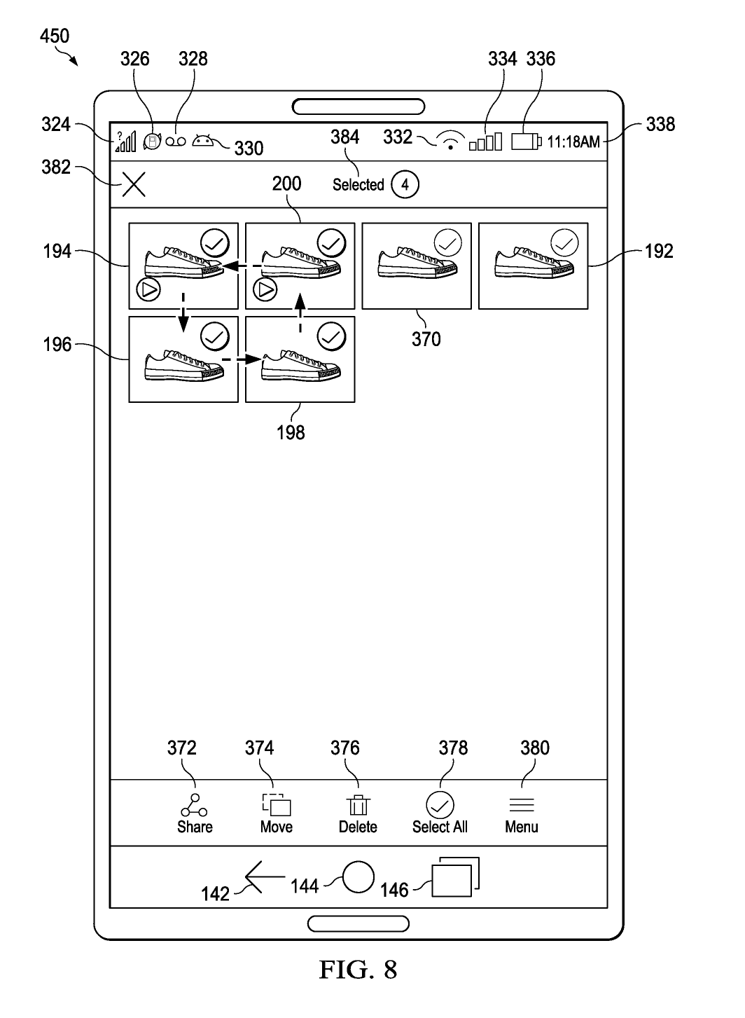

FIG. 8 illustrates display 450 of a smartphone, where multi-touch rotation is performed on pictures. Display 450 depicts pictures 194, 196, 198, 200, 370, and 192. Also, display 450 includes cellular signal strength indicator 324, indicator 326, new voicemail indicator 328, indicator 330, WiFi strength indicator 332, battery level indicator 334, charging status indicator 336, clock 338, back button 142, home button 144, and menu button 146. Additionally, display 450 contains close window button 382, selection indicator 384, share button 372, move button 374, delete button 376, select all button 378, and menu button 380. Pictures 194, 196, 198, and 200 are selected. A user places fingers on the selected pictures and rotates the pictures in a counter-clockwise motion, which rotates the position of the pictures counter-clockwise. In another example, the pictures are rotated clockwise using a clockwise motion.

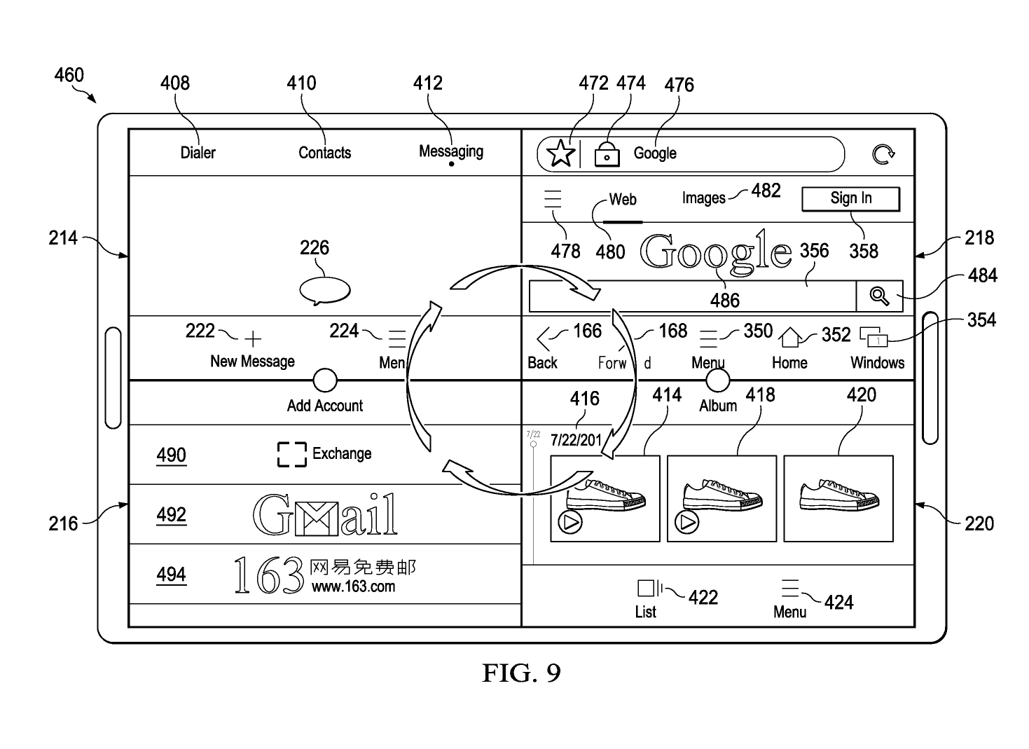

FIG. 9 illustrates display 460 of a tablet where the position of windows is rotated using multi-touch rotation. Four windows, messaging center window 214, e-mail exchange window 216, web browser window 218, and photo album window 220, are open. Messaging center window 214 includes dialer button 408, contacts button 410, messaging button 412, message display 226, new message button 222, and menu button 224. The messaging center is used to send and receive messages. Also, e-mail exchange window 216 contains an e-mail exchange to send and receive messages, with exchange button 490, Gmail™ button 492, and 163 web portal button 494. Web browser window 218 depicts a Google Chrome™ web browser with bookmark button 472, lock button 474, Google™ icon 476, sign in button 358, settings button 478, web button 480, images button 482, Google™ logo 486, search bar 356, search button 484, back button 166, forward button 168, menu button 350, home button 352, and windows button 354. Photo album window 220 contains a photo album with pictures 414, 418, and 420, timestamp 416, list button 422, and menu button 424. A user performs a rotational multi-touch gesture on messaging center window 214, e-mail exchange window 216, web browser window 218, and photo album window 220 to rotate the window layout. A user places fingers the four windows, and rotates the fingers in a clockwise motion, causing the layout positions of the windows to also rotate clockwise. In another example, the windows are rotated counter-clockwise using a counter-clockwise multi-touch rotational motion.

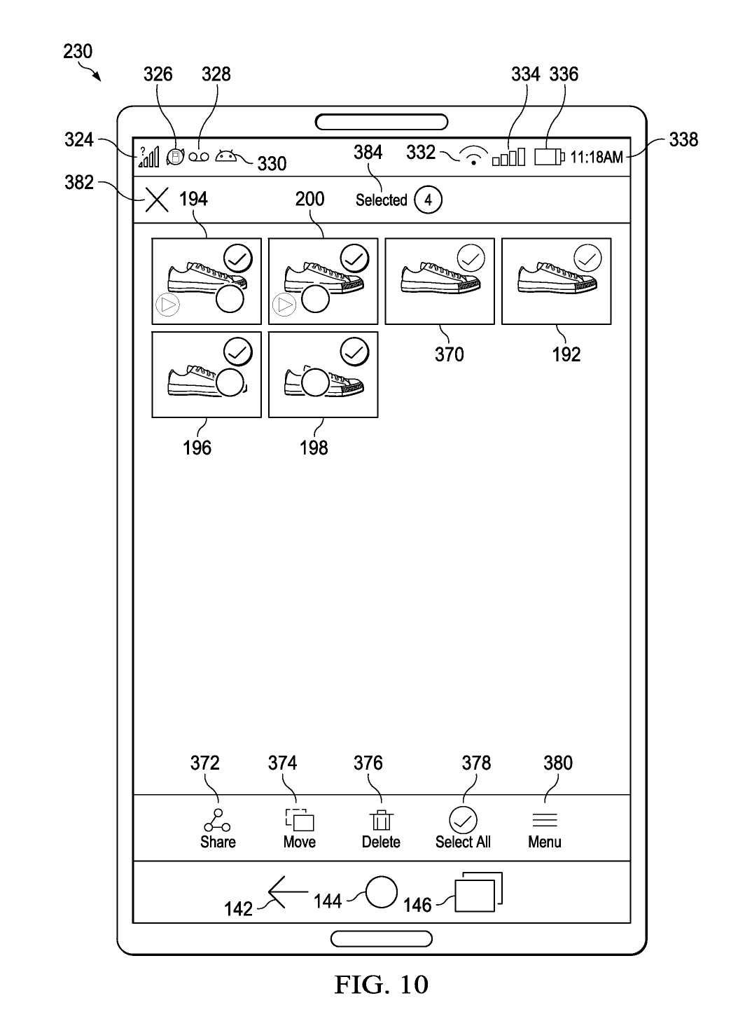

FIG. 10 illustrates display 230 of a smartphone where a multi-touch hold motion is used to select icons. Display 230 depicts pictures 194, 196, 198, 200, 370, and 192, along with cellular signal strength indicator 324, indicator 326, new voicemail indicator 328, indicator 330, WiFi strength indicator 332, battery level indicator 334, charging status indicator 336, and clock 338, back button 142, home button 144, and menu button 146. Additionally, display 230 contains close window button 382, selection indicator 384, share button 372, move button 374, delete button 376, select all button 378, and menu button 380. Pictures 194, 196, 198, and 200 are selected. A user touches and holds his fingers on pictures 194, 196, 198, and 200 to select them. After the touch is held for a predetermined amount of time, a menu of options pops up. Options in the menu may include delete, cut, copy, and share in a gallery application. The user may then decide whether to perform one of the listed options on the selected pictures. Other options may be displayed when a multi-touch hold motion is performed on other objects, such as windows or icons.

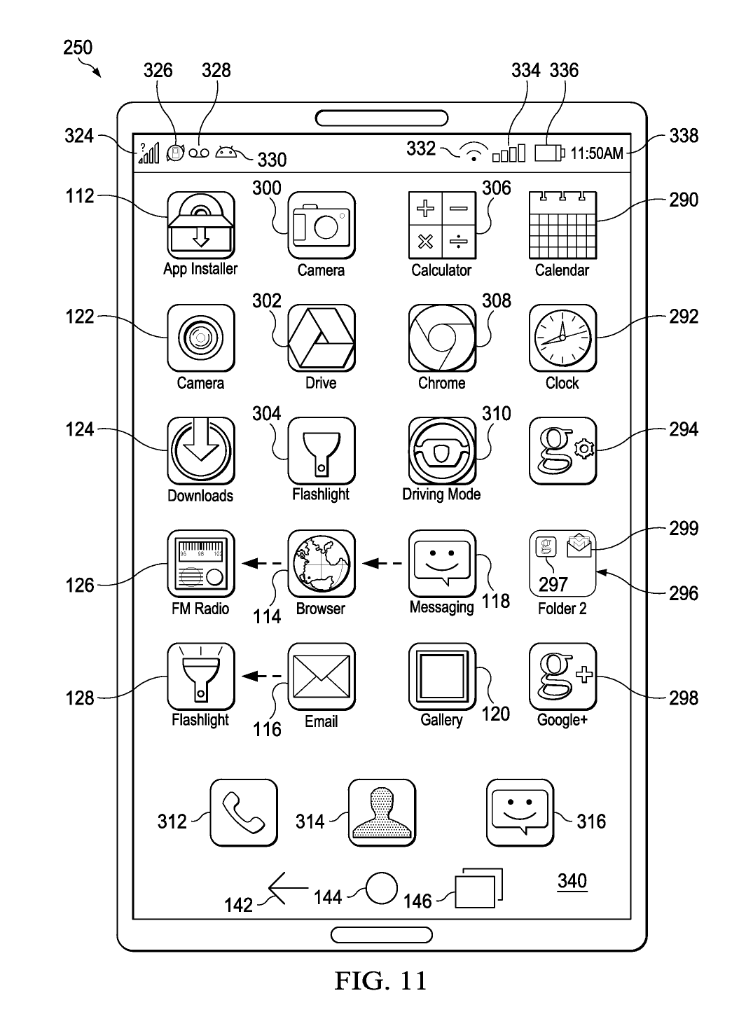

FIG. 11 illustrates display 250 of a smartphone, where a multi-touch drag gesture is performed on icons. Display 250 shows background 340, cellular signal strength indicator 324, indicator 326, new voicemail indicator 328, indicator 330, WiFi strength indicator 332, battery level indicator 334, charging status indicator 336, and clock 338. Also, display 250 contains back button 142, home button 144, menu button 146, and a variety of icons, including phone icon 312, contacts icon 314, messaging icon 316, application installer icon 112, camera icon 300, calculator icon 306, calendar icon 290, camera icon 122, Google Drive™ icon 302, Google Chrome™ icon 308, clock icon 292, downloads icon 124, flashlight icon 304, driving mode icon 310, Google™ settings icon 294, FM radio icon 126, browser icon 114, messaging icon 118, folder icon 296, which contains Google™ icon 297 and mail icon 299, flashlight icon 128, e-mail icon 116, gallery icon 120, and Google+™ icon 298. The user places fingers on browser icon 114, messaging icon 118, and e-mail icon 116. Multiple fingers are held and moved in one direction, towards the left to move the icons towards the left. When the icons are dragged sufficiently far, they are moved to the next screen to the left. In other examples, icons are dragged in other directions, such as to the right, up, down, or diagonally. In another example, a user drags multiple icons to a trash box to delete the shortcut to the applications in the idle screen or to uninstall the applications corresponding to the icons when the icons in the idle screen represent the actual application.

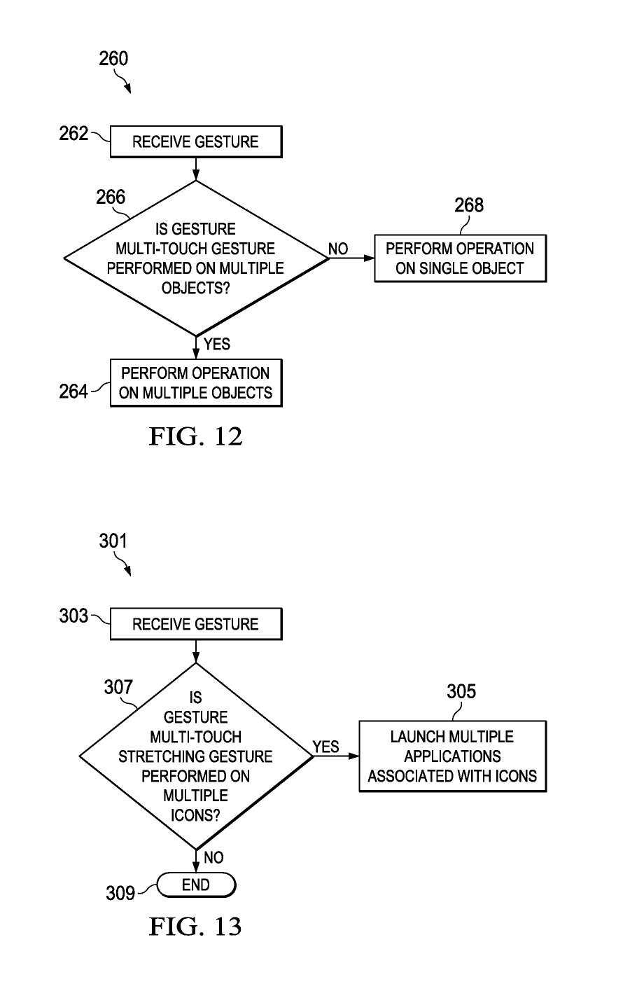

FIG. 12 illustrates flowchart 260 for an embodiment method of using multi-touch gestures on multiple objects. Initially, in step 262, a gesture is received by a touch-screen display of a device. The device may be a smart phone, tablet, phablet, personal digital assistant (PDA), satellite navigation device, video games, or electronic books, or another device, such as a hand held computer or game console. In additional examples, the device is a specialty device, such as an automated teller machine (ATM), kiosk, industrial device, or medical device. In other examples, the device is a touch-screen display attached to a computer, or attached to a network as a terminal. Various touch-screen technologies, such as resistive technology, SAW, capacitive technology, including surface capacitance, projected capacitance, infrared grid, infrared acrylic projection, optical imaging, dispersive signal technology, and acoustic pulse technology, may be used. The touch(es) are detected by the touch-screen display. The positions and movement of the touch(es) are detected.

Next, in step 266, the device determines whether the gesture received in step 262 is a multi-touch gesture performed on multiple objects. When the gesture is a multi-touch gesture performed on multiple objects, the device proceeds to step 264 to perform an operation on the multiple objects. On the other hand, when the gesture is not a multi-touch gesture performed on multiple objects, the device proceeds to step 268 to perform an operation on a single object. An object may be an icon, a window, a picture, or another object, such as a folder, document, sound file, video file, phone number, e-mail address, map, graph, or another file type such as diagram. Objects are discrete visual items which span a portion of the display. There may be a gap between objects, for example between icons. Alternatively, objects, such as windows, are adjacent to each other. In one example, the multi-touch gesture is performed by fingers. One, two, three, four or more fingers on one hand or two hands may be used. In another example fingers of multiple users are used. Instead of fingers, a stylus, pen, or other pointing device may be used for some or all of the touches. Two, three, four, or more touches may be performed in a multi-touch gesture. A variety of multi-touch gestures, such as stretching, pinching, rotating, holding, dragging, tapping, sliding, and/or swiping may be used. In one example, more than one gesture type is used at a time. The multi-touch gesture touches multiple objects to act on multiple objects at the same time.

In step 264, an operation is performed on multiple objects in accordance with the multi-touch gesture detected in step 266. In one example, multiple applications are launched by performing a multi-touch gesture on multiple icons. The applications associated with the touched icons are launched. Two, three, four, or more applications may be opened in multiple windows. Multiple objects, for example multiple icons, multiple folders, or multiple files, may be combined in a folder based on a multi-touch gesture. In another example, multiple pictures may be combined to form a single picture from a multi-touch gesture. In an additional example, multiple applications and/or windows are closed with a single multi-touch gesture. A layout of objects, such as icons, pictures, windows, files, folders, or other objects may be adjusted based on a multi-touch gesture. For example, the objects may be rotated or dragged. Objects may be dropped into a folder for organization or into a trash can for deletion. A menu with multiple options for operations to be performed on multiple objects may pop up. The user can then select an operation to perform on the objects. For example, a menu with options to delete, cut, copy, or share pictures may be used in gallery application. A menu with options may pop up when icons, windows, or other objects, such as files or folders, are selected by a multi-touch gesture. Different options for operations may be used for different types of objects. When icons are selected, operations may include opening, deleting, or forming a folder. For example, when pictures are selected, operations may include deleting, cutting, copying, and sharing. In another example, icons, applications associated with icons, files, or folders are deleted. In one example, different operations are performed on different objects.

In step 268, an operation is performed on a single object, or not operation is performed.

FIG. 13 illustrates flowchart 301 of a method of performing multi-touch stretching on multiple objects. Initially, in step 303, a device receives a gesture. The device may be a smart phone or a tablet. The gesture is received on a touch-screen display of the device. The touch-screen display may include a display, sensors, a controller, and software for a CPU. The touch-screen display determines the location of the touch(es).

Next, in step 307, the device determines whether the gesture received in step 303 is a multi-touch stretching gesture performed on multiple icons. In a multi-touch stretching gesture, there are multiple touches on the touch-screen display, where the multiple touches move apart from each other. The touch-screen display detects the presence, location, and movement of the touches. The multi-touch stretching gesture is on multiple objects when the touches begin on or in the vicinity of multiple icons. When the device detects a multi-touch stretching gesture performed on multiple icons, the device proceeds to step 305. On the other hand, when the device does not detect a multi-touch stretching gesture performed on multiple icons, it proceeds to step 309.

In step 305, the device launches applications associated with the multiple icons on which the gesture is performed. When two applications are launched, they may be displayed in portrait mode. When four applications are launched, they may be displayed in four quadrants. The user may then use the opened applications.

In step 309, multiple applications are not launched at the same time, and the procedure ends.

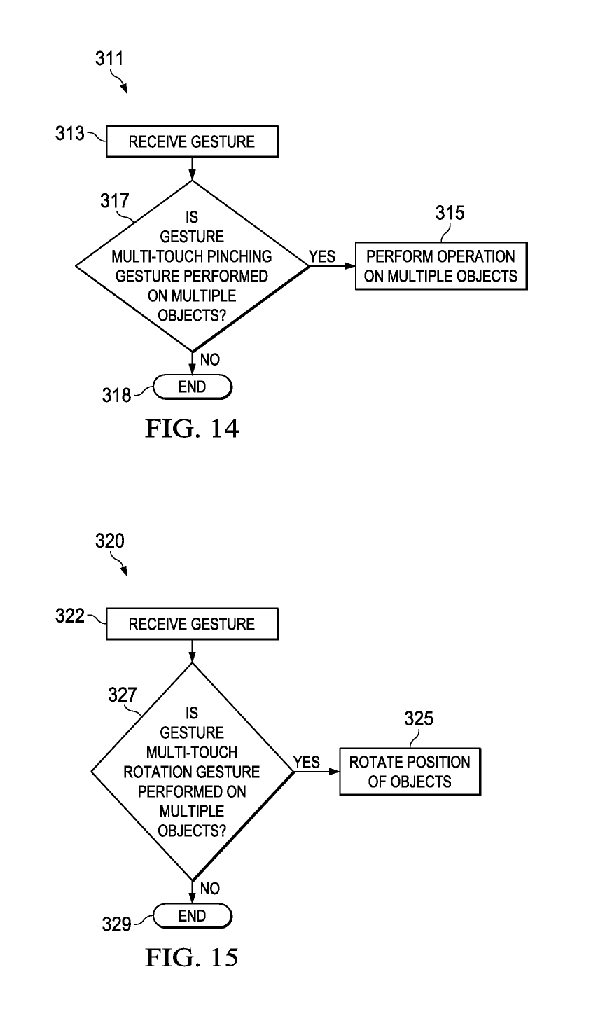

FIG. 14 illustrates flowchart 311 for a multi-touch pinching gesture performed on multiple objects. Initially, in step 313, the device receives a gesture. Example devices include smartphones and tablets. The gesture is received on a touch-screen display of the device. The touch-screen display may include a display, sensors, a controller, and software for a CPU. The touch-screen display determines the presence, location, and movement of the touch(es).

Then, in step 317, the device determines whether the gesture received in step 313 is a multi-touch pinching gesture performed on multiple objects. When multi-touch pinching is performed on multiple objects, multiple touches are received on or near multiple objects. The touches move inwards relatively towards each other in a pinching motion. When the device detects a multi-touch pinching gesture on multiple objects, it proceeds to step 315. On the other hand, when the device does not detect a multi-touch pinching gesture, it proceeds to step 318.

In step 315, the device performs an operation on the multiple objects acted on in step 317. For example, when multiple icons are acted on, the icons are combined in a folder. In another example, when multiple pictures are acted on, the pictures are combined to form one larger picture. In an additional example, multiple windows are acted on, and the multiple windows are closed.

In step 318, multiple objects are not acted on by a multi-touch pinching gesture, and the procedure ends.

FIG. 15 illustrates flowchart 320 for an embodiment method of rotating multiple objects using a multi-touch rotational gesture. Initially, in step 322, the device receives a gesture. The device may be a smartphone or tablet. The gesture is received on a touch-screen display of the device. The touch-screen display may include a display, sensors, a controller, and software for a CPU. The touch-screen display determines the presence, location, and movement of the touch(es).

Next, in step 327, the device determines whether the gesture received in step 322 is a multi-touch rotational gesture performed on multiple objects. In multi-touch rotation, multiple touches are detected on or near multiple objects. Then, the touches move in a rotational motion. The rotation may be clockwise or counter-clockwise. When the device detects a multi-touch rotational gesture on multiple objects, it proceeds to step 325. On the other hand, when the device does not detect a multi-touch rotational gesture on multiple objects, it proceeds to step 329.

In step 325, the device rotates the positions of the objects acted on in the display layout. Icons, pictures, or windows may be rotated. The layout of the objects may be rotated in the same direction as the rotational motion. Alternatively, the layout of the objects is rotated in the opposite direction to the direction of the gesture rotation. The amount of rotation of the layout may be similar to or proportional to the amount of rotation of the gesture. For example, a small rotational gesture may rotate the objects by 90 degrees, while a large rotational gesture rotates the objects by 180 degrees. Other amounts of rotation, such as 30 degrees, 45 degrees or 60 degrees may be used. In another example, the layout rotation is by a fixed amount, for example by 90 degrees or 180 degrees.

In step 329, multiple objects are not acted on by a multi-touch rotational gesture, and the procedure ends.

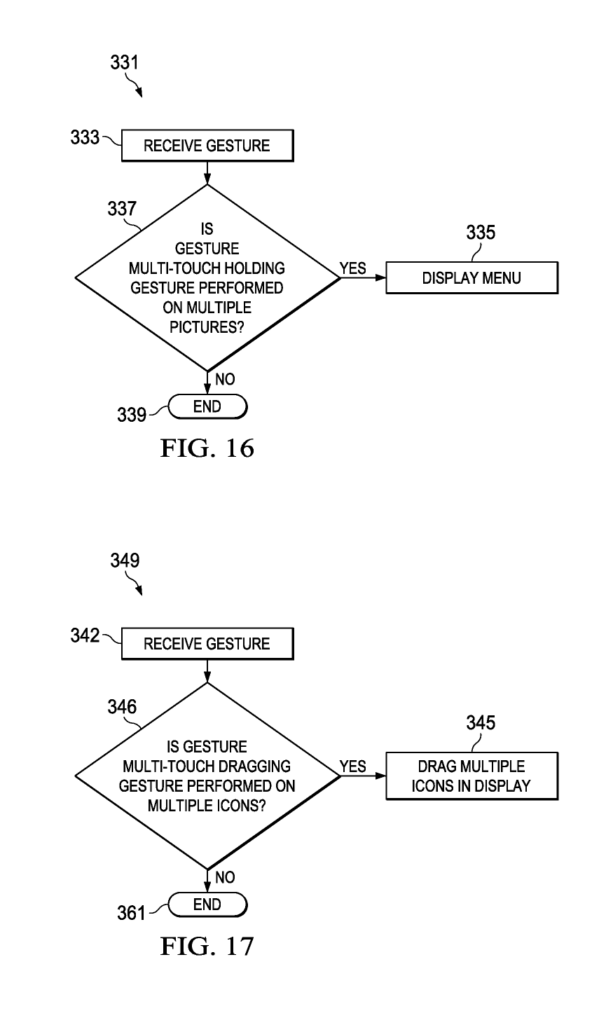

FIG. 16 illustrates flowchart 331 for an embodiment method of receiving a multi-touch holding gesture on multiple pictures. Initially, in step 333, a touch-screen display of a device receives a gesture. In one example, the device is a smartphone or another device, such as a tablet. The touch-screen display may include a display, sensors, a controller, and software for a CPU. The touch-screen display determines the presence, location, and movement of the touch(es).

Then, in step 337, the device determines whether the gesture received in step 333 is a multi-touch holding gesture performed on multiple pictures. In a multi-touch holding gesture, multiple touches are detected on or near objects. The touch gesture is held, for example for a pre-determined length of time, such as one second, two seconds, five seconds, or ten seconds, with little to no movement. A multi-touch holding gesture on multiple pictures is detected when the multi-touch holding motion is performed on multiple pictures. When a multi-touch holding gesture is detected on multiple pictures, the device proceeds to step 335. When a multi-touch holding gesture is not detected on multiple pictures, the device proceeds to step 339.

In step 335, a menu is displayed to the user in the display of the touch-screen display. The menu may include options such as, for example, delete, cut, copy, or share the pictures. A user may select one of the options, for example by touching the menu option on the touch-screen display. The selection is detected by the touch-screen display. Then, the operation selected from the menu is performed on the pictures acted on in step 337. For example, all the pictures on which the multi-touch holding gesture is performed are deleted, cut, copied, or shared.

In step 339, multi-touch holding is not performed on multiple objects, and the procedure ends.

FIG. 17 illustrates flowchart 349 for a method of acting on multiple icons from a multi-touch dragging motion performed on multiple icons. Initially, in step 342, a gesture is received on a touch-screen display of a device. The device may be a smartphone, or another device, such as a tablet. The touch-screen display may include a display, sensors, a controller, and software for a CPU. The touch-screen display determines the presence, location, and movement of the touch(es).

Then, in step 346, the device determines whether the gesture detected in step 342 is a dragging multi-touch motion performed on multiple icons. When a dragging multi-touch motion is performed on multiple icons displayed in the touch-screen display, multiple touches are detected on or near multiple icons. The touches are moved in the same direction in a dragging motion. In another example, the dragging motion is in different directions. The dragging motion may be left, right, up, down, diagonally, or at another angle. When a multi-touch dragging motion is detected on multiple icons, the device proceeds to step 345. On the other hand, when a multi-touch dragging motion on multiple icons is not detected, the device proceeds to step 361.

In step 345, the multiple icons on which the multi-touch dragging gesture is performed on are moved. For example, the locations of the icons may be moved. In one example, the icons are moved in the same direction as the direction of the dragging gesture. Alternatively, the icons are moved in another direction, such as the opposite direction. In one example, the amount the icons are dragged is proportional to the magnitude of the dragging gesture. In another example, the icons are moved by a set amount. The icons may be moved to another screen, for example to the screen to the left or to the right of the screen which is currently being displayed. In an additional example, the icons are dragged to a trash box to delete the shortcut in the idle screen or to uninstall the applications when the icons on the idle screen represent real applications.

In step 361, a multi-touch dragging gesture is not performed on multiple icons, and the procedure ends.

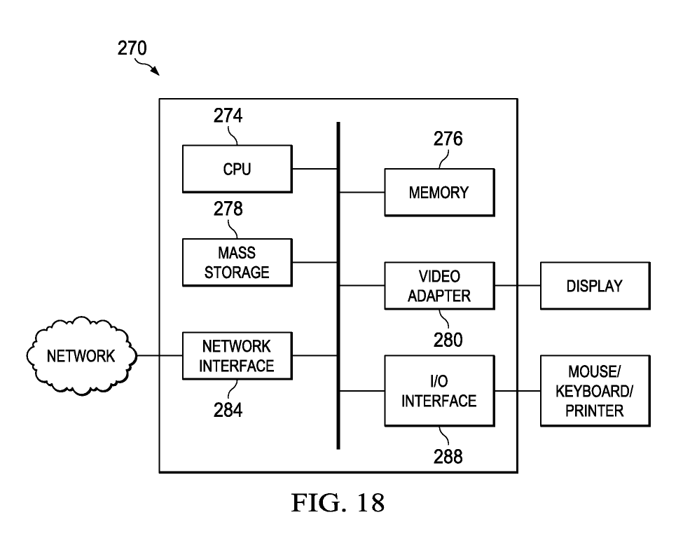

FIG. 18 illustrates a block diagram of processing system 270 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input devices, such as a microphone, mouse, touchscreen, keypad, keyboard, and the like. Also, processing system 270 may be equipped with one or more output devices, such as a speaker, a printer, a display, and the like. The processing unit may include central processing unit (CPU) 274, memory 276, mass storage device 278, video adaptor 280, and I/O interface 288 connected to a bus.

The bus may be one or more of any type of several bus architectures including a memory bus or memory controller, a peripheral bus, video bus, or the like. CPU 274 may comprise any type of electronic data processor. Memory 276 may comprise any type of non-transitory system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

Mass storage device 278 may comprise any type of non-transitory storage device configured to store data, programs, and other information and to make the data, programs, and other information accessible via the bus. Mass storage device 278 may comprise, for example, one or more of a solid state drive, hard disk drive, a magnetic disk drive, an optical disk drive, or the like.

Video adaptor 280 and I/O interface 288 provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface card (not pictured) may be used to provide a serial interface for a printer.

The processing unit also includes one or more network interface 284, which may comprise wired links, such as an Ethernet cable or the like, and/or wireless links to access nodes or different networks. Network interface 284 allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method comprising:
receiving, by a touch screen display of a device from a user, a gesture on the touch screen display of the device;
determining whether the gesture is a multi-touch gesture on a plurality of objects displayed on the touch screen display of the device;
producing a detected multi-touch gesture when the gesture is the multi-touch gesture on the plurality of objects displayed on the touch screen display of the device; and
performing an operation on the plurality of objects in accordance with the detected multi-touch gesture.

2. The method of claim 1, wherein the multi-touch gesture is stretching, wherein the plurality of objects is a plurality of icons, and wherein performing the operation on the plurality of objects comprises opening a plurality of windows associated with the plurality of icons.

3. The method of claim 1, wherein the multi-touch gesture is pinching, and wherein performing the operation on the plurality of objects comprises placing the plurality of objects in a folder.

4. The method of claim 1, wherein the multi-touch gesture is pinching, wherein the plurality of objects is a plurality of pictures, and wherein performing the operation on the plurality of objects comprises combining the plurality of pictures in a combined picture.

5. The method of claim 1, wherein the multi-touch gesture is pinching, wherein the plurality of objects is a plurality of windows, and wherein performing the operation on the plurality of objects comprises closing the plurality of windows.

6. The method of claim 1, wherein the multi-touch gesture is rotation, and wherein performing the operation on the plurality of objects comprises rotating the plurality of objects.

7. The method of claim 6, wherein the plurality of objects is selected from a group consisting of a plurality of icons, a plurality of pictures, a plurality of windows, and combinations thereof.

8. The method of claim 1, wherein the multi-touch gesture is holding, and wherein performing the operation on the plurality of objects comprises:
displaying a menu of a plurality of actions;
receiving, by the device, a selected action of the plurality of actions; and
performing the selected action on the plurality of objects.

9. The method of claim 8, wherein the plurality of actions comprise at least one of deleting, cutting, copying, and sharing.

10. The method of claim 1, wherein the multi-touch gesture is dragging, wherein the plurality of objects is a plurality of icons, and wherein performing the operation on the plurality of objects comprises dragging the plurality of icons.

11. The method of claim 1, wherein the multi-touch gesture is dragging, wherein the plurality of objects is a plurality of icons, and wherein performing the operation on the plurality of objects comprises deleting the plurality of icons.

12. The method of claim 1, wherein the plurality of objects is selected from the group consisting of two objects, three objects, and four objects.

13. A device comprising:
a touch-screen display configured to receive a gesture on the touch screen display;
a processor; and
a non-transitory computer readable storage medium storing programming for execution by the processor, the programming including instructions to
determine whether the gesture is a multi-touch gesture on a plurality of objects displayed on the touch screen display of the device,
produce a detected multi-touch gesture when the gesture is the multi-touch gesture on the plurality of objects displayed on the touch screen display of the device, and
perform an operation on the plurality of objects in accordance with the detected multi-touch gesture.

14. The device of claim 13, the multi-touch gesture is stretching, wherein the plurality of objects is a plurality of icons, and wherein the instructions to perform the operation on the plurality of objects comprises instructions to open a plurality of windows associated with the plurality of icons.

15. The device of claim 13, wherein the multi-touch gesture is rotation, and wherein the instructions to perform the operation on the plurality of objects comprises instructions to rotate the plurality of objects.

16. The device of claim 13, wherein the multi-touch gesture is holding, and wherein the instructions to perform the operation on the plurality of objects comprises instructions to:
display a menu of a plurality of actions;
receive, by the device, a selected action of the plurality of actions; and
perform the selected action on the plurality of objects.

17. The device of claim 13, wherein the multi-touch gesture is pinching, and wherein the instructions to perform the operation on the plurality of objects comprises instructions to place the plurality of objects in a folder.

18. The device of claim 13, wherein the multi-touch gesture is pinching, wherein the plurality of objects is a plurality of pictures, and wherein the instructions to perform the operation on the plurality of objects comprises instructions to combine the plurality of pictures in a combined picture.

19. The device of claim 13, wherein the multi-touch gesture is pinching, wherein the plurality of objects is a plurality of windows, and wherein the instructions to perform the operation on the plurality of objects comprises instructions to close the plurality of windows.

20. A computer program product for installation on a device, the computer program product comprising programming for execution by the device, the programming including instructions to:
receive, by a touch screen display of a device from a user, a gesture on the touch screen display of the device;
determine whether the gesture is a multi-touch gesture on a plurality of objects displayed on the touch screen display of the device;
produce a detected multi-touch gesture when the gesture is the multi-touch gesture on the plurality of objects displayed on the touch screen display of the device; and
perform an operation on the plurality of objects in accordance with the detected multi-touch gesture.
